(19) United States
(12) Patent Application Publication
(10) Pub. No.: US 2003/0204630 A1
(43) Pub. Date: Oct. 30, 2003

(54) Bandwidth-efficient and secure method to combine multiple live events to multiple exhibitors

(75) Inventor: Joseph S. Ng, Montebello, CA (US)

Correspondence Address: GATES & COOPER LLP, HOWARD HUGHES CENTER, 6701 CENTER DRIVE WEST, SUITE 1050, LOS ANGELES, CA, 90045, US

(73) Assignee: The Boeing Company

(21) Appl. No.: 10/213,396

(22) Filed: Aug. 6, 2002

Related U.S. Application Data
(60) Provisional application No. 60/376,333, filed on Apr. 29, 2002.

(51) Int. Cl. G06F 15/16

(52) U.S. Cl. 709/248; 725/94; 725/63

(57) ABSTRACT

An apparatus and method for combining multiple live events in a bandwidth-efficient and secure manner is disclosed. A typical system includes a plurality of live event sites each producing a live video source for transmission and a live event director system. The live event director system selects one of the plurality of live event sites and synchronizes transmission among the plurality of live event sites so that only the live video source of the selected one of the plurality of live event sites is transmitted for exhibition at a time. The transmission from the selected live event site is compressed and encrypted for broadcast to one or more exhibitors.

### CROSS-REFERENCE TO RELATED APPLICATIONS

This application claims the benefit under 35 U.S.C. §119(e) of the following co-pending and commonly-assigned U.S. patent application, which is incorporated by reference herein:

United States Provisional Patent Application No. 06/376,333, filed Apr. 29, 2002, by Joseph S. Ng and entitled “BANDWIDTH EFFICIENT AND SECURE METHOD TO COMBINE MULTIPLE LIVE EVENTS TO MULTIPLE EXHIBITORS”.

This application is related to the following co-pending and commonly-assigned U.S. patent applications, which are both incorporated by reference herein:

U.S. Provisional Application Serial No. 60/376,105, filed Apr. 29, 2002, by Charles F. Stirling, Bernard M. Gudaitis, William G. Connelly and Catherine C. Girardey, entitled “SECURE DATA CONTENT DELIVERY SYSTEM FOR MULTIMEDIA APPLICATIONS UTILIZING BANDWIDTH EFFICIENT MODULATION”; and

U.S. Provisional Application Serial No. 60/376,244, filed Apr. 29, 2002, by Ismael Rodriguez and James C. Campanella, entitled “A METHOD TO SECURELY DISTRIBUTE LARGE DIGITAL VIDEO/DATA FILES WITH OPTIMUM SECURITY”.

### BACKGROUND OF THE INVENTION

1. Field of the Invention

The present invention relates to systems and methods for transmitting presentations to multiple viewing locations from multiple simultaneous sources. Particularly, this invention relates to transmitting secure live events from multiple simultaneous sources and locations to multiple exhibitors.

2. Description of the Related Art

Presenting live events securely from multiple simultaneous sources and locations to be broadcast worldwide is very difficult and expensive. It is especially difficult to do so at high definition or cinema quality levels. Such high quality transmission require an excessive amount of bandwidth to transmit.

In the prior art, the approach is to send the high definition quality digital video, compressed and encrypted to a production facility simultaneously from each of the sources/locations. At the production facility, each source is then decompressed and decrypted. As the separate sources are received live, the producer selects a desired source from among the delivered high definition quality digital video for a particular period of time. The desired source is then compressed, encrypted and broadcast to all the exhibitors for the period of time. A different source can be selected as desired for the next period of time as a single seamless edited transmission is produced from the production facility in real time. At an exhibitor site, the signal is then decrypted, decompressed and projected to the screen for viewing.

The problem with the prior art approach is that it requires simultaneous wide bandwidth communication between each of the multiple sources/locations and the production facility. Each source must be made available at all times for the production facility to create the single edited transmission. This requirement makes it cost inhibiting to broadcast a multi source event live. The total bandwidth requirement for the existing approach is (N+1)*B, where N is the number of sources (e.g., live event sites), B is the bandwidth required for each encrypted, compressed high definition or cinema quality digital video communication. The bandwidth requirement increases directly in proportion with the number of live source event sites as well as the desired video quality level.

To save costs using the existing approach, video quality may be sacrificed. Thus, high definition quality is about the limit within a reasonable cost model. Higher quality (e.g., cinema quality) simultaneous multiple source live event broadcasts have not been done. Even for high definition quality, only high budget productions and a limited number of live event sites have been used due to the high communication costs.

There is a need for systems and methods for cost effective broadcasting of live events in higher quality video from multiple live sources. Further, there is a need for such systems and methods to function using less bandwidth.

### SUMMARY OF THE INVENTION

Embodiments of the invention combine compression, encryption, satellite communication, GPS, computer control, decompression, decryption and image processing technologies to enable high definition or cinema quality live event from multiple simultaneous sources and locations to be broadcast worldwide in a bandwidth-efficient manner. Embodiments of the invention employ a bandwidth-efficient technique that enables events such as Olympic games, major events, conferences, company meetings, political convention, and political campaign to be broadcast in high definition or cinema quality nationwide or worldwide in a cost effective manner.

A typical system includes a plurality of live event sites each producing a live video source for transmission and a live event director system. The live event director system selects one of the plurality of live event sites and synchronizes transmission among the plurality of live event sites so that only the live video source of the selected one of the plurality of live event sites is transmitted for exhibition at a time. The transmission from the selected live event site is compressed and encrypted for broadcast to one or more exhibitors.

Further, embodiments of the invention provide a bandwidth-efficient and secure method for combining multiple simultaneous sources of live events in high definition or cinema grade quality to distribute to multiple exhibitors worldwide. Thus, a substantial cost savings is realized while also allowing the live events site to be located anywhere within a satellite coverage.

Embodiments of the invention provide a new technological service, the ability to broadcast multiple simultaneous sources of live events in high definition or cinema quality to multiple exhibitors in a bandwidth-efficient manner.

### BRIEF DESCRIPTION OF THE DRAWINGS

Referring now to the drawings in which like reference numbers represent corresponding parts throughout:

FIG. 1 illustrates a basic architecture of an exemplary system of the present invention;

FIG. 2 illustrates the details of an exemplary exhibitor system;

FIG. 3 illustrates the details of an exemplary live event site system;

FIG. 4 illustrates a typical live event director system of the invention; and

FIG. 5 illustrates a typical network operation center of the invention.

### DETAILED DESCRIPTION OF THE PREFERRED EMBODIMENT

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

1. Overview

One object of this invention is to reduce the bandwidth required to broadcast high definition or cinema quality digital video to (1)* B regardless of the number of live event sites N. This substantially reduces the cost of the overall broadcast. To achieve this goal, embodiments of the invention use a live event director system (LEDS) to coordinate among the multiple live event sites and selects only one live event site to broadcast directly to the exhibitors at any given time. The selected live event site will transmit to a satellite which broadcasts to the exhibitors. In other words, rather than being centrally edited in the final video quality (e.g., at a network operation center) for redistribution to the exhibitors, only the delivered overall broadcast exists in final video quality, remotely edited together.

Very accurate timing synchronization should be used to present a seamless broadcast to the exhibitors. To perform positioning determinations, global positioning system (GPS) system receivers include the functionality of extremely accurate (atomic level) clocks. These clocks can be used by the live event director system and live event sites to provide a common time reference for enabling and disabling transmission to synchronize the handoff of transmission from one live event site to the next.

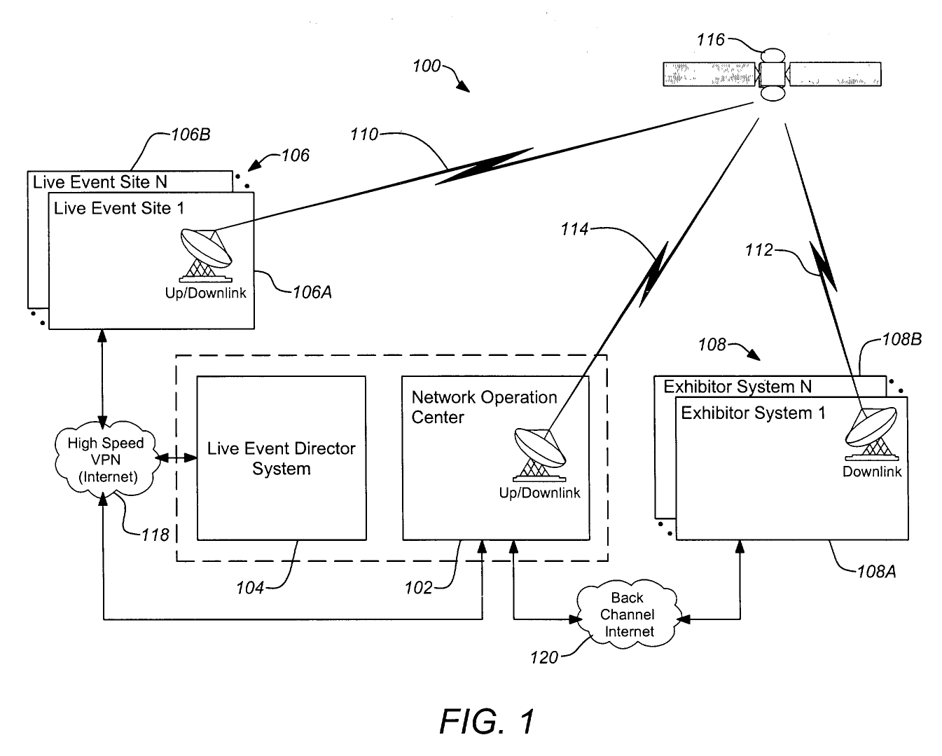

FIG. 1 illustrates a basic architecture of an exemplary system of the present invention. There are four major subsystems used by the system 100, the network operation center 102 (NOC), the live event director system 104 (LEDS), a plurality of live event sites 106 (LES) (individually designated as 106A, 106B, etc.) and one or more exhibitor systems 108 (ES) (individually designated as 108A, 108B, etc.). The live event sites 106 each provide a live video source available for inclusion in the overall broadcast via a satellite link 110. Each exhibitor system 108 receives the overall broadcast, synchronously transmitted from the plurality of live event sites 106, via satellite link 112. The transmissions from each of the live event sites 106 are synchronized by the live event director system 104 so that only one live event site 106 is transmitting to the exhibitor systems 108 at a time. Thus, only one uplink from one of the live event sites 106 is active at a time. The network operation center 102 manages access control of the exhibitor systems 108 to the overall broadcast through satellite link 114. Although alternate delivery methods are possible, preferably the overall broadcast is transmitted through one or more satellites 116.

The live event director system 104 is used to select one of the live event sites 106 to transmit live video at a time. The live event director system 104 synchronizes the transmission among the plurality of live event sites 106 so that only the live video source from the selected live event site 106 is transmitted for exhibition at one time. To do this, the live event director system 104 must coordinate the transition from one live event site 106 transmission to the next. Coordination of video transmission from the plurality of live event sites 106 must be done with great precision so that there is no detectible lapse or overlap between the transmissions from the separate live event sites 106 received at the exhibitor systems 108. The overall broadcast received by the exhibitor systems 108 should appear seamless.

Coordination of the overall broadcast is managed over a less costly, lower director system bandwidth communication link between the live event sites 106, the live event 104 and the network operation center 102. For example, a high speed virtual private network (VPN) 118 over the Internet can be used. Each of the live event sites 106 sends low resolution video of its available live video source to the live event director system 104. The live event director system 104 provides transmission timing information back to the live event sites 106 and the network operation center to coordinate the overall broadcast. In addition, a back channel Internet 120 connection (which may also be a VPN connection) can also be used between the exhibitor systems 108 and the network operation center 108 to access and billing.

In the description hereafter, the details of the subsystems of FIG. 1 and the method of operation will be further described.

2. Exhibitor System

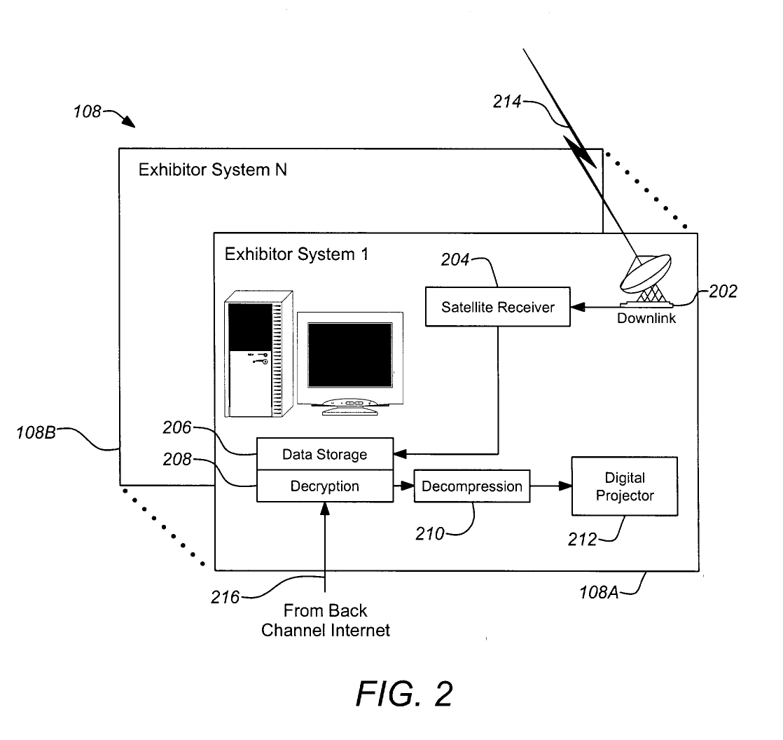

FIG. 2 illustrates the details of an exemplary exhibitor system 108. An exhibitor system 108 is provided so that patrons can view a transmitted multi-sourced live event. An exhibitor system 108 is located at each of one or more N exhibition locations as shown in FIG. 1. There is no limit to the number of exhibition locations. For example, they can number in the tens of thousands. There are six major components in a typical exhibitor system 108, the down link antenna 202, satellite receiver 204, data storage 206, a decryption unit 208, a decompression unit 210, and a display device 212 (e.g., a digital projector or other suitable device).

The down link antenna 202 and satellite receiver 204 are used to receive the signal 214 from the satellite 116 and decode the received data from the signal 214. The data storage 206 is used to buffer the received data. Buffering the data can assure an uninterrupted presentation even if the transmission of the overall broadcast is temporarily interrupted. In addition, data storage 206 can be used to store the entire live event (i.e. the overall broadcast), so that it may also be replayed at the exhibition location at a later time. When the event is exhibited (live, delayed or replayed), the received data is passed to the decryption unit 208.

The decryption unit 208 performs two decryption functions, the transmission decryption and the conditional access decryption. Transmission decryption is performed on all received transmissions. Conditional access decryption decrypts the signal only if the exhibitor is entitled to use the signal. Access authorization is confirmed via a communication link 216 to the decryption unit 208 from the network operation center 102. The communication link 216 supplies the proper decryption keys. The communication link 216 can be implemented in a variety of ways, such as wireless, satellite, telephone connection and/or any other suitable connection. The keys for transmission decryption and conditional access decryption can be communicated together over the same link or separate links. Preferably, the communication link 216 comprises an Internet connection, such as a back channel Internet connection. Furthermore, the link 216 should provide its own encryption for added security to the keys.

Once decrypted, the data is then passed to the decompression unit 210. The decompression unit 210 restores the received compressed signal back to its original form just before it is relayed to the display device 212 for presentation to the audience. To provide yet more security to the transmission, the final relay from the storage device to the display device 212 can be separately encrypted and decrypted within the display device as the video is presented. The display device 212 is used to display the received decrypted and decompressed image. For example, a digital projector can be used to project the high definition or cinema quality image to a screen.

In one embodiment, transmission decryption and decompression are performed upon receipt of the signal and the output is cached to data storage 206. When the video is to be displayed (immediately, in the case of a live broadcast), the conditional access decryption is performed actively as the video is transferred from data storage 206 to the display device 212. Thus, the overall broadcast is stored on the data storage 206 with only the conditional access encryption applied. The conditional access key must be available if the video is to be replayed.

Errors in synchronization may occur when switching from one event site to another. To safeguard against any potential gaps in the received signal, the system will automatically repeat a current frame until a new frame is available. For example, at the end of a frame, if no new signal is available to be decompressed, the decompression unit 210 will repeat the current frame. Thus, if there is any transmission error, the audience will not detect any interruption.

3. Live Event Site

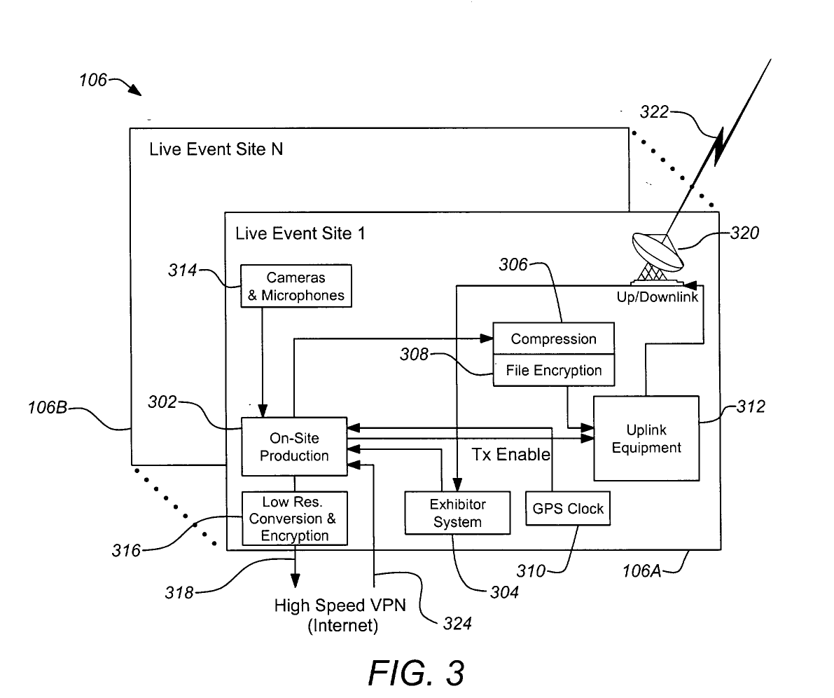

FIG. 3 illustrates the details of an exemplary live event site system 106. A live event site system 106 is located at each of the live event sites; the overall system 100 can operate using numerous live event sites. There are six major components in each live event site system 106, an on-site production unit 302, an exhibitor system 304, a compression unit 306, a file encryption unit 308, a GPS clock 310, and up-link equipment 312. Each live event site contains input devices 314, such as one or more cameras and microphones to provide raw video and audio to the system 100. The input devices 314 are connected to the on-site production unit 302. The on-site production unit 302 locally processes the high definition or cinema quality video and audio streams, performs selection, mixing, special effects, and recording functions as necessary, for time shifting or instant replay. A live event on-site director directs and coordinates the on site production activity. The on-site director may act autonomously or at the direction of a central director at the live event director system 104. The high definition or cinema quality digital video signal produced from the on-site production feeds into two paths.

Along the first path, video is compressed to lower resolution video, encrypted 316 and sent to the event director system 104 over a secure low resolution link 318, such as a high speed virtual private network (VPN). As discussed later, the event director system 104 will use this lower resolution video to determine which video source (high resolution) to select for the overall broadcast.

Along the second path, the high definition or cinema quality digital video is compressed 306 and encrypted 308 and then made available to the up-link equipment 312. Based on the commands from the live event director system 104 coming through a control link 324 (for example, using the same high speed VPN) and the time reference from the GPS clock 310, the on site production 302 component will generate the transmission command (Tx) to enable or disable the up-link equipment 312. The uplink equipment 312 communicates the processed signal 322 to the antenna 320 for transmission to the satellite 116. The satellite 116 broadcasts the high quality video of the processed signal 322 to the exhibitor systems 108.

The encryption unit 308 performs both transmission encryption and conditional access encryption. The encryption can be performed using many possible techniques. For example, the encryption for both transmission and conditional access encryption can be based upon a hardware encryption (e.g., an application specific integrated circuit) that is part of the encryption unit. The transmission encryption can be applied over the conditional access encrypted data so that the received video can be “transmission” decrypted and then stored with the conditional access encryption still applied. Upon viewing (live or replayed), the video is “conditional access” decrypted in real-time.

Alternately, either or both encryptions can be software based with paired keys (encrypt keys for the live event sites 106 and decrypt keys for the exhibitor systems 108) coordinated by the network operation center 102 through wireless, satellite, telephone or any other suitable link. For example, using the secure two-way VPN link (that also communicates controls from the live event director system 104), the encryption key(s) can be conveniently communicated to the live event sites 106 over this same link 324. In alternate embodiments, either or both the transmisison and conditional access encryptions can be performed by hardware or software with or without paired encryption/decryption keys.

Although not necessary for operation of the invention, the live event site 106 can also include an local exhibitor system 304. The exhibitor system 304 operates in the same manner as the system shown in FIG. 2 and can be thought of as an additional exhibition site colocated with the live event site. To facilitate this the antenna 320 functions as both an uplink and downlink. The local exhibitor system 304 provides the live event on-site director with what the audience is viewing in high definition or cinema quality.

4. Live Event Director System

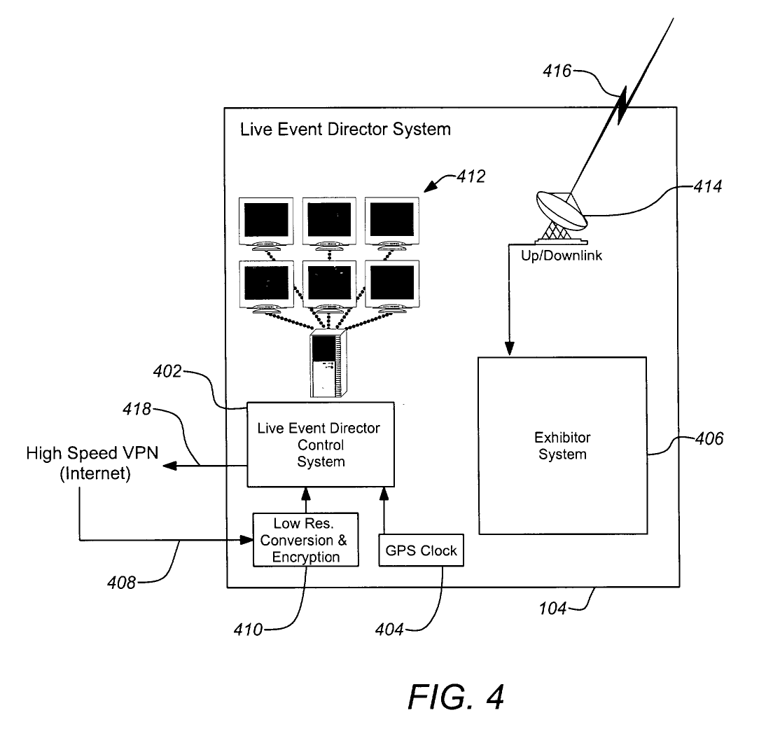

FIG. 4 illustrates a typical live event director system 104 of the invention. The live event director system 104 is the main command and control portion of the overall system. The live event director system 104 commands which live event site transmits (On-Air) using a GPS clock 404 as a common reference. There are three major components in the live event director system 104, the live event director control system 402, the GPS clock 404 and the exhibitor system 406. The live event director control system 402 receives low resolution (such as 320×240) video from each live event site 106 through a low resolution link 408 (e.g. a high speed VPN), decrypts and decompresses 410 the video streams and displays on the monitors 412 for viewing.

The live event director will decide which live event site to transmit in the overall broadcast based on voice communication (through the high speed VPN) and the low-resolution video from all live event sites. The live event director control system 402 will send a message communicated over a control link 418 specifying which live event site will transmit next and at what GPS referenced time. The control link 418 can be conveniently communicated over the same VPN connection, however, it can also be communicated over a separate secure connection, e.g. wireless, telephone, satellite or other suitable link. If there is a live event site 106A currently transmitting, it will stop transmission at the commanded GPS referenced time, and the selected live event site 106B will start transmission at the commanded GPS referenced time. As previously described, during the transition, if the next frame is not transmitted successfully, the exhibitor systems 108 will repeat the current frame and the audience will not detect any interruption. The GPS clock 404 is used to provide a common reference time.

The exhibitor system 406 at the live event director site is used to provide the live event director system 104 with the overall broadcast that the audience is viewing in the high definition or cinema quality. The exhibitor system 406 operates in the same manner as the exhibitor system detailed in FIG. 2. A downlink antenna 414 is provided to receive the overall broadcast signal 416.

The live event director system 104 can be a stand alone system located at a separate location, or it can be colocated with the network operation center 102, at a live event site 106 or at a studio. Colocation at one of these sites will enable the system 104 to share equipment, such as the downlink antenna and/or exhibitor system 406.

5. Network Operation Center

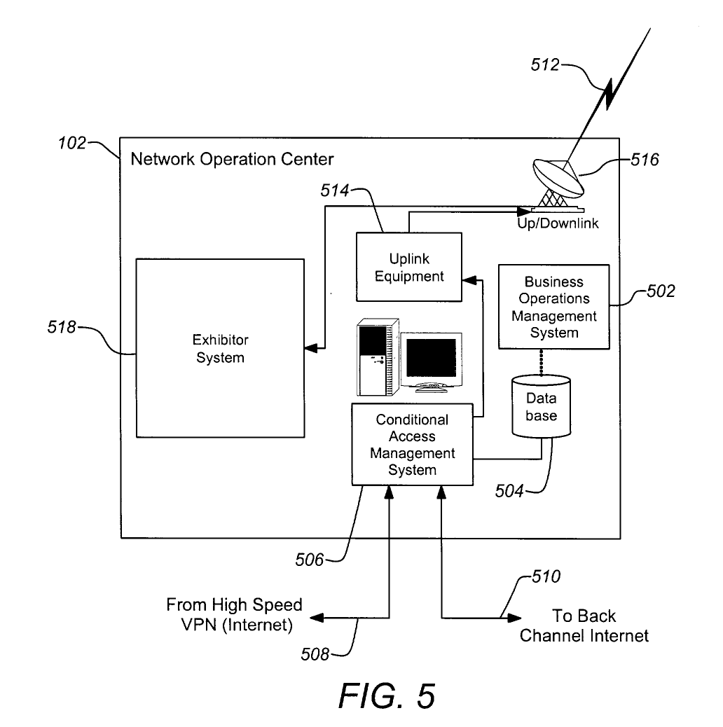

FIG. 5 illustrates a typical network operation center 102 of the invention. The network operation center 102 (NOC) is used to perform use and rights management for the overall broadcast. The NOC 102 will provide transmission decryption keys and conditional access decryption keys to exhibitor systems 108 before the live event broadcast starts and/or add exhibitor systems 108 during live event broadcast.

The business operations management system 502 manages a database 504 of authorized exhibitor systems 108 and the events that they are authorized to exhibit. The conditional access management system 506 will communicate the proper conditional access encryption keys to the various live event sites 106, e.g. over the VPN link 508. In addition, the conditional access management system 506 will communicate the paired decryption keys to the authorized exhibitor systems 108, e.g. over a back channel Internet link 510.

The transmission decryption keys are also communicated by the NOC 102 to the exhibitor systems 108. The transmission decryption keys can also be delivered via wireless, telephone or other suitable link, however they are typically delivered through a satellite transmission. For example, the transmission decryption keys are communicated by satellite signal 512 through the uplink equipment 514 and antenna 516.

Just as with the live event director system 104 and the live event sites 106, the network operation center 102 can use an exhibitor system 518 to monitor what the audience is viewing in the high definition or cinema quality. The exhibitor system 518 of the network operation center 102 operates in the same manner as the exhibitor systems 108 shown in FIG. 2.

### CONCLUSION

This concludes the description including the preferred embodiments of the present invention. The foregoing description of the preferred embodiment of the invention has been presented for the purposes of illustration and description. It is not intended to be exhaustive or to limit the invention to the precise form disclosed. Many modifications and variations are possible in light of the above teaching.

It is intended that the scope of the invention be limited not by this detailed description, but rather by the claims appended hereto. The above specification, examples and data provide a complete description of the manufacture and use of the apparatus and method of the invention. Since many embodiments of the invention can be made without departing from the scope of the invention, the invention resides in the claims hereinafter appended.

What is claimed is:

1. A system comprising:
a plurality of live event sites each producing a live video source for transmission; and
a live event director system for selecting one of the plurality of live event sites and synchronizing transmission among the plurality of live event sites so that only the live video source of the selected one of the plurality of live event sites is transmitted at a time for exhibition.

2. The system of claim 1, wherein the synchronization is performed using global positioning system (GPS) clocks at the plurality of live event sites and the live event director system.

3. The system of claim 1, wherein the live event director system communicates commands for synchronizing transmission among the plurality of live event sites over a control link to each of the live event sites.

4. The system of claim 1, wherein the transmitted live video source is transmitted via satellite broadcast to at least one live exhibition site.

5. The system of claim 1, wherein the live video source comprises high definition quality video.

6. The system of claim 1, wherein the live video source comprises cinema quality video.

7. The system of claim 1, wherein the live video source of each of the plurality of live event sites is compressed to a low resolution video and communicated to the live event director system.

8. The system of claim 7, wherein the low resolution video is communicated through virtual private network (VPN) connection.

9. The system of claim 1, further comprising at least one exhibitor system for receiving the live video transmission from the selected one of the plurality of live event sites.

10. The system of claim 9, wherein the exhibitor system includes:
a receiver for receiving and extracting video data from the live video transmission;
data storage for buffering the video data;
a decryption unit for decrypting the video data;
a decompression unit decompressing the video data; and
a display device for displaying the decrypted and decompressed video data.

11. The system of claim 9, wherein a current frame of the received live video is repeated if there is a gap in the live video transmission.

12. The system of claim 9, wherein the live video source is compressed and encrypted at the live event site for transmission to the at least one exhibitor system where the live video source is decrypted and decompressed prior to exhibition.

13. The system of claim 12, wherein at least one decryption key for decrypting the live video source is communicated to the at least one exhibitor system from a network operation center.

14. The system of claim 12, wherein the encryption includes transmission encryption and conditional access encryption.

15. The system of claim 14, wherein the received live video source is stored and the transmission encryption is decrypted before the live video source is stored and the conditional access encryption is decrypted after the live video source is stored but before the live video source is played.

16. A method comprising the steps of:
producing a live video source at each of a plurality of live event sites; and
selecting one of the plurality of live event sites; and
synchronizing transmission among the plurality of live event sites with a live event director system so that only the live video source of the selected one of the plurality of live event sites is transmitted at a time for exhibition.

17. The method of claim 16, wherein synchronization is performed using global positioning system (GPS) clocks at the plurality of live event sites and the live event director system.

18. The method of claim 16, wherein the live event director system communicates commands for synchronizing transmission among the plurality of live event sites over a control link to each of the live event sites.

19. The method of claim 16, wherein the transmitted live video source is transmitted via satellite broadcast to at least one live exhibition site.

20. The method of claim 16, wherein the live video source comprises high definition quality video.

21. The method of claim 16, wherein the live video source comprises cinema quality video.

22. The method of claim 16, wherein the live video source of each of the plurality of live event sites is compressed to a low resolution video and communicated to the live event director system.

23. The method of claim 22, wherein the low resolution video is communicated through virtual private network (VPN) connection.

24. The method of claim 16, further comprising receiving the live video transmission from the selected one of the plurality of live event sites at at least one exhibitor system.

25. The method of claim 24, wherein the exhibitor system includes:
a receiver for receiving and extracting video data from the live video transmission;
data storage for buffering the video data;
a decryption unit for decrypting the video data;
a decompression unit decompressing the video data; and
a display device for displaying the decrypted and decompressed video data.

26. The method of claim 24, wherein a current frame of the received live video is repeated if there is a gap in the live video transmission.

27. The method of claim 24, wherein the live video source is compressed and encrypted at the live event site for transmission to the at least one exhibitor system where the live video source is decrypted and decompressed prior to exhibition.

28. The method of claim 27, wherein at least one decryption key for decrypting the live video source is communicated to the at least one exhibitor system from a network operation center.

29. The method of claim 27, wherein the encryption includes transmission encryption and conditional access encryption.

30. The method of claim 29, wherein the received live video source is stored and the transmission encryption is decrypted before the live video source is stored and the conditional access encryption is decrypted after the live video source is stored but before the live video source is played.
